(19) United States
(12) Patent Application Publication
(10) Pub. No.: US 2026/0262640 A1
(43) Pub. Date: Sep. 10, 2026

(54) LIQUID COMPOSITIONS CONTAINING 5-(FLUORO-4-IMINO-3-METHYL)-1-TOSYL-3,4 DIHYDROPYRIMIDINE-(1H)-ONE AND DERIVATIVES THEREOF AND A UV ABSORBER

(71) Applicant: ADAMA MAKHTESHIM LTD., Beer Sheva (IL)

(72) Inventors: Jenny LERNER YARDENI, Mishmar Hanegev (IL); Hanan SERTCHOOK, Gedera (IL); Anna PANARIN, Beer Sheva (IL)

(73) Assignee: ADAMA MAKHTESHIM LTD., Beer Sheva (IL)

(21) Appl. No.: 19/164,920

(22) PCT Filed: Mar. 13, 2024
(86) PCT No.: PCT/IB2024/052437

§ 371 Date: Sep. 12, 2025

Related U.S. Application Data
(60) Provisional application No. 63/452,139, filed on Mar. 14, 2023.
(60) Provisional application No. 63/452,140, filed on Mar. 14, 2023.

(51) Int. Cl. A01N 43/54; A01N 25/22; A01P 3/00

(52) U.S. Cl. CPC A01N 43/54; A01N 25/22; A01P 3/00

(57) ABSTRACT

The present invention provides a method of controlling UV degradation of a compound of formula (I),

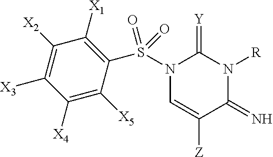

wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen,
comprising protecting the compound of formula (I) from UV light.

This application claims the benefit of U.S. Provisional Application No. 63/452,140, filed Mar. 14, 2023, and U.S. Provisional Application No. 63/452,139, filed Mar. 14, 2023, the contents of which are hereby incorporated by reference.

Throughout this application various publications are referenced. The disclosures of these documents in their entireties are hereby incorporated by reference into this application in order to more fully describe the state of the art to which this invention pertains.

### BACKGROUND

5-fluoro-4-imino-3-methyl-1-tosyl-3,4-dihydropyrimidin-2(1H)-one is a compound which provides control of a variety of pathogens affecting economically important crops including, but not limited to, the causal agent of leaf blotch in wheat, Zymoseptoria tritici (SEPTTR) and fungi of the classes ascomycetes and basidiomycetes.

Uses of N3-substituted-N1-sulfonyl-5-fluoropyrimidinone derivatives as fungicides were described in U.S. Pat. No. 8,263,603, issued Sep. 11, 2012, the content of which is incorporated herein by reference in its entirety. Methods of preparation of 5-fluoro-4-imino-3-methyl-1-tosyl-3,4-dihydropyrimidin-2 (1H)-one were described in U.S. Pat. No. 9,850,215, issued Dec. 26, 2017, U.S. Pat. No. 9,840,476, issued Dec. 12, 2017, and PCT International Application Publications Nos. WO 2021/059160 A1, published Apr. 1, 2021 and WO 2021/181274, published Sep. 16, 2021, the contents of each of which are incorporated herein by reference in their entirety.

U.S. Pat. No. 8,263,603 also described fungicidal compositions for the control or prevention of fungal attack comprising N3-substituted-N1-sulfonyl-5-fluoropyrimidinone derivatives and a phytologically acceptable carrier material, and methods of use thereof.

Use of 5-fluoro-4-imino-3-(alkyl/substituted alkyl)-1-(arylsulfonyl)-3,4-dihydropyrimidin-2(1H)-one as seed treatment to prevent or control plant disease was described U.S. Patent Application Publication No. 2018/0000082, published on Jan. 4, 2018.

Synergistic mixtures comprising 5-fluoro-4-imino-3-methyl-1-tosyl-3,4-dihydropyrimidin-2(1H)-one and at least one fungicidal sterol biosynthesis inhibitor were described in U.S. Pat. No. 9,526,245, issued Dec. 27, 2016 and U.S. Pat. No. 10,045,533, issued Aug. 14, 2018.

Synergistic mixtures comprising 5-fluoro-4-imino-3-methyl-1-tosyl-3,4-dihydropyrimidin-2(1H)-one and at least one succinate dehydrogenase inhibitor were described in U.S. Pat. No. 9,532,570, issued Jan. 3, 2017 and U.S. Pat. No. 10,045,534, issued Aug. 14, 2018.

Synergistic mixtures comprising 5-fluoro-4-imino-3-methyl-1-tosyl-3,4-dihydropyrimidin-2(1H)-one and an amount of at least one fungicide (A) selected from the group consisting of fluindapyr, pydiflumetofen, mefentrifluconazole, inpyrfluxam, isofetamid and Qi inhibitor were described in PCT International Application Publication No. WO 2021/014346 A1, published Jan. 28, 2021.

In view of the exceptional efficacy of 5-fluoro-4-imino-3-methyl-1-tosyl-3,4-dihydropyrimidin-2(1H)-one in controlling fungal attack on a plant, there is a significant need for stable compositions comprising 5-fluoro-4-imino-3-methyl-1-tosyl-3,4-dihydropyrimidin-2(1H)-one.

Fungicidal compositions are frequently applied under various conditions, and the biological activity and efficacy of the fungicide may be affected for various reasons.

International patent application publication No. WO/2020/095181 discloses liquid compositions comprising (a) a fungicidally effective amount of a compound of Formula I and (b) a liquid carrier that are both chemically and physically stable.

The object of the present invention was to increase the efficacy of the compound -fluoro-4-imino-3-methyl-1-tosyl-3,4-dihydropyrimidin-2(1H)-one, and to provide liquid compositions comprising thereof, wherein the compound fluoro-4-imino-3-methyl-1-tosyl-3,4-dihydropyrimidin-2(1H)-one is stable, especially after application.

It was surprisingly found that protecting 5-fluoro-4-imino-3-methyl-1-tosyl-3,4-dihydropyrimidin-2(1H)-one from UV light increased the stability and efficacy of the active.

It was further surprisingly found that adding a UV absorber to a composition comprising the compound 5-fluoro-4-imino-3-methyl-1-tosyl-3,4-dihydropyrimidin-2(1H)-one, increased the stability and efficacy of the active.

Composition comprising a pesticide and a UV absorber are known, for example from WO/2019/052898, WO/2008/085682 and GB 2127691. However, the compounds of the present invention do not bear any of the photolabile moieties disclosed in the prior art publications. Thus, it was very surprising that protecting -fluoro-4-imino-3-methyl-1-tosyl-3,4-dihydropyrimidin-2 (1H)-one from UV light, or the addition of a UV absorber to a composition comprising 5-fluoro-4-imino-3-methyl-1-tosyl-3,4-dihydropyrimidin-2 (1H)-one provided a chemically stable composition.

### SUMMARY

The present invention provides a method of controlling UV degradation 15 of a compound of formula (I),

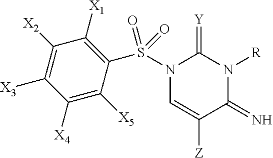

wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen,
comprising protecting the compound of formula (I) from UV light.

The present invention further provides a combination of a compound of formula (I) and a UV protectant.

The present invention provides a liquid composition comprising a compound of formula (I) and at least one UV absorber.

The present invention further provides a method of controlling the degradation of a compound of formula (I), the method comprising combining at least one UV absorber and the compound of formula (I) in a liquid composition.

The present invention further provides use of at least one UV absorber for controlling the degradation of a compound of formula (I) in a liquid composition.

The present invention also provides a method for controlling a plant disease comprising contacting the plant or a locus of the plant with an effective amount of the composition described herein to thereby control the plant disease.

The present invention also provides a method for controlling a plant disease comprising applying to the plant or a locus of the plant the compound of formula (I) in a low-UV light environment.

### DETAILED DESCRIPTION OF THE INVENTION

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

The term “a” or “an” as used herein includes the singular and the plural, unless specifically stated otherwise. Therefore, the terms “a,” “an,” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”. In each such instance, the terms “comprising,” “consisting essentially of,” and “consisting of” are intended to have the same meaning as each such term would have when used as the transition phrase of a patent claim.

For purposes of better understanding the present teachings and in no way limiting the scope of the teachings, unless otherwise indicated, all numbers expressing quantities, percentages, or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, used of the term “about” herein specifically includes ±10% from the indicated values in the range. In addition, the endpoints of all ranges directed to the same component or property herein are inclusive of the endpoints, are independently combinable, and include all intermediate points and ranges.

As used herein, the term “w/w” means percentage by weight based on the total weight of the composition.

As used herein, the term “liquid” means a liquid that is not a gas.

As used herein, the term “controlling a plant disease” means treating a plant infected with a plant disease or protecting a plant from a plant disease.

The term “plant” means seedling, any part of the plant such as root or foliage, soil, or a locus of infestation.

As used herein, the term “UV absorber” means any compound that functions by the absorption of UV light.

The present invention provides a method of controlling UV degradation of a compound of formula (I),

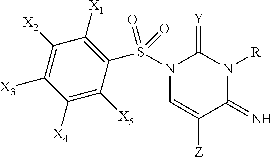

wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen,
comprising protecting the compound of formula (I) from UV light.

The term “protecting” as described herein means to placing the compound of formula (I) in a container with UV protection, placing the compound of formula (I) in a low UV light environment, or to combine the compound of formula (I) with a UV absorber.

The term “placing” means storing, transporting or applying to the plant or to a locus of the plant.

One skilled in the art would know to appreciate that the terms “low UV light environment” is relative due to multiple factors. Generally, the term “low UV light environment” means low levels of sunlight when there is a high amount of cloud cover and/or nighttime.

In some embodiments, the UV absorber is selected from benzotriazoles.

Suitable benzotriazoles are the compound 2-(2H-benzotriazol-2-yl)-4, 6-ditertpentylphenol (Tinuvin 328), 2-(5-chloro-2H-benzotriazol-2-yl)-6-(1,1-dimethylethyl)-4-methyl phenol (Tinuvin 326), 2-(2H-Benzotriazol-2-yl)-4,6-bis(1-methyl-1-phenylethyl)phenol (Tinuvin 234), and 2-(2′-Hydroxy-3′,5′-di-tert-butylphenyl)-5-chlorobenzotriazole (Tinuvin 327).

In some embodiments, the compound of formula (I) is formulated in a liquid composition.

Suitable liquid composition according to the present invention are selected from emulsion concentrate (EC), suspoemulsion concentrates (SE), oil-in-water (EW) and microemulsion (ME).

In some embodiments, the compound of formula (I) is dissolved in the formulation.

In some embodiment, the compound of formula (I) is dissolved is a solvent selected from acetophenone, benzyl acetate, N-butylpyrolidone such as Genegen NBP, N-Formylmorpholine such as ARMID FMPC, cyclohexanone, DMSO and NMP.

The present invention further provides a combination of a compound of formula (I), wherein the substituents are as previously described, and a UV protectant.

UV protectant may be a container with UV protection, or a UV absorber.

In some embodiments, the UV absorber is selected from benzotriazoles.

Suitable benzotriazoles are the compound 2-(2H-benzotriazol-2-yl)-4, 6-ditertpentylphenol (Tinuvin 328), 2-(5-chloro-2H-benzotriazol-2-yl)-6-(1,1-dimethylethyl)-4-methyl phenol (Tinuvin 326), 2-(2H-Benzotriazol-2-yl)-4,6-bis(1-methyl-1-phenylethyl)phenol (Tinuvin 234), and 2-(2′-Hydroxy-3′,5′-di-tert-butylphenyl)-5-chlorobenzotriazole (Tinuvin 327).

In some embodiments, the compound of formula (I) in combination with a UV protectant is more efficient for controlling a fungal infection in a plant or locus than the compound of formula (I) without UV protectant.

In some embodiments, fungicidal efficacy is increased by at least 5%, 10%, 20%, or 30% compared to when the same amount of the compound of formula (I) is without the UV protectant. In some embodiments, fungicidal efficacy is increased by at least 50%, 100%, 200% or 300% compared to when the same amount of the compound of formula (I) is without the UV protectant.

In some embodiments, fungicidal efficacy is measured in a treated area of the plant. In some embodiments, fungicidal efficacy is measured in an untreated area of the plant. In some embodiments, fungicidal efficacy is increased in a treated area of the plant. In some embodiments, fungicidal efficacy is increased in an untreated area of the plant.

In some embodiments, fungicidal efficacy is measure at least 7 days after treatment. In some embodiments, fungicidal efficacy is measure at least 14 days after treatment. In some embodiments, fungicidal efficacy is measure at least 21 days after treatment. In some embodiments, fungicidal efficacy is measure at least 28 days after treatment.

In some embodiments, a substantially similar level of fungicidal efficacy is achieved by using a lesser amount of the compound of Formula (I).

In some embodiments, the compound of formula (I) is formulated in a liquid composition, such as emulsion concentrate (EC), suspoemulsion concentrates (SE), oil-in-water (EW) and microemulsion (ME).

The present invention provides a liquid composition comprising a compound of formula (I)

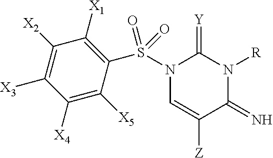

wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid, halogen, —SH, —OH, —NH₂, —NO₂, —CN or CF₃;
Y is O or S;
and Z is a halogen;
and at least one UV absorber.

Compositions according to the invention comprise from about 0.1 to 5% by weight of UV absorber based on the total wight of the composition. In one embodiment, the compositions comprise from about 0.5 to 3% by weight, of UV absorber based on the total weight of the composition. In one embodiment, the compositions comprise from about 1% to 2% by weight, of UV absorber based on the total weight of the composition. In one embodiment, the compositions comprise about 1% by weight, of UV absorber based on the total weight of the composition. In one embodiment, the compositions comprise about 1.5% by weight, of UV absorber based on the total weight of the composition. In one embodiment, the compositions comprise about 2% by weight, of UV absorber based on the total weight of the composition.

The concentration of the UV absorber is about 1 to 50 g/L, based on the total weight of the composition. In some embodiments, the concentration of the UV absorber is about 10 to 21 g/L, based on the total weight of the composition, including each value within the specified range. Each possibility represents a separate embodiment of the invention. The concentration of the compound of Formula (I) is from about 0.1% to 20% by weight, based on the total wight of the composition. In some embodiments, the concentration of the compound of Formula (I) is from about 1% to 10% by weight, based on the total wight of the composition. In some embodiments, the concentration of the compound of Formula (I) is from about 4% to 7% by weight, based on the total wight of the composition. In some embodiments, the concentration of the compound of Formula (I) is about 5% by weight, based on the total wight of the composition.

The concentration of the compound of Formula (I) is about 1 to 200 g/L, based on the total wight of the composition. In some embodiments, the concentration of the compound of Formula (I) is from about 10 g/L to 100 g/L, based on the total wight of the composition. In some embodiments, the concentration of the compound of Formula (I) is from about 40 g/L to 70 g/L, based on the total wight of the composition. In some embodiments, the concentration of the compound of Formula (I) is about 50 g/L, based on the total wight of the composition.

The weight ratio between the compound of Formula (I) and the UV absorber is between 200:1 to 1:50. In some embodiments, the weight ratio between the compound of Formula (I) and the UV absorber is between 10:1 to 1:1. In some embodiments, the weight ratio between the compound of Formula (I) and the UV absorber is between 5:1 to 1:1. the weight ratio between the compound of Formula (I) and the UV absorber is between 10:1 to 2:1. In some embodiments, the weight ratio between the compound of Formula (I) and the UV absorber is between 5:1 to 2:1.

In some embodiments, the UV absorber is selected from benzotriazoles.

Suitable benzotriazoles are the compound 2-(2H-benzotriazol-2-yl)-4, 6-ditertpentylphenol (Tinuvin 328), 2-(5-chloro-2H-benzotriazol-2-yl)-6-(1,1-dimethylethyl)-4-methyl phenol (Tinuvin 326), 2-(2H-Benzotriazol-2-yl)-4,6-bis(1-methyl-1-phenylethyl)phenol (Tinuvin 234), and 2-(2′-Hydroxy-3′,5′-di-tert-butylphenyl)-5-chlorobenzotriazole (Tinuvin 327).

In some embodiments, the composition comprises a photoinitiator.

In some embodiments, the photoinitiator is the solvent.

In some embodiments, the solvent is selected from acetophenone, benzyl acetate, N-butylpyrolidone such as Genegen NBP, N-Formylmorpholine such as ARMID FMPC, cyclohexanone, DMSO and NMP.

In some embodiments, acetophenone acts as the photoinitiator.

In some embodiments, the composition further comprises at least one additive such as an antifreeze, a stabilizer, a tackifier, a preservative, a surfactant, and a combination thereof.

Compositions according to the invention can be prepared as described in WO/2020/095181 which is hereby incorporated by reference in its entirety.

In some embodiments, the composition or the combination further comprises at least one additional agrochemical.

In some embodiments, the composition or the combination of the present invention further comprises at least one additional pesticide. In some embodiments, the pesticide is a fungicide, herbicide, insecticide, or nematicide.

In some embodiments, the composition or the combination of the present invention further comprises at least one additional fungicide.

In some embodiments, the at least one additional fungicide is a fungicidal sterol biosynthesis inhibitor.

In some embodiments, the sterol biosynthesis inhibitor is selected from the group consisting of prothioconazole, epoxiconazole, cyproconazole, myclobutanil, prochloraz, metconazole, difenoconazole, tebuconazole, tetraconazole, fenbuconazole, propiconazole, fluquinconazole, flusilazole, flutriafol, and fenpropimorph.

In some embodiments, the sterol biosynthesis inhibitor is selected from the group consisting of prothioconazole, epoxiconazole, metconazole, difenoconazole, propiconazole, prochloraz, tetraconazole, tebuconazole, fenpropimorph, fenpropidin, ipconazole, triticonazole, spiroxamine, fenhexamid, and fenpyrazamine.

In some embodiments, the sterol biosynthesis inhibitor is prothioconazole. In some embodiments, the sterol biosynthesis inhibitor is epoxiconazole. In some embodiments, the sterol biosynthesis inhibitor is cyproconazole. In some embodiments, the sterol biosynthesis inhibitor is myclobutanil. In some embodiments, the sterol biosynthesis inhibitor is metconazole. In some embodiments, the sterol biosynthesis inhibitor is difenoconazole. In some embodiments, the sterol biosynthesis inhibitor is propiconazole. In some embodiments, the sterol biosynthesis inhibitor is prochloraz. In some embodiments, the sterol biosynthesis inhibitor is tetraconazole. In some embodiments, the sterol biosynthesis inhibitor is tebuconazole. In some embodiments, the sterol biosynthesis inhibitor is fluquinconazole. In some embodiments, the sterol biosynthesis inhibitor is flusilazole. In some embodiments, the sterol biosynthesis inhibitor is flutriafol. In some embodiments, the sterol biosynthesis inhibitor is fenpropimorph. In some embodiments, the sterol biosynthesis inhibitor is fenpropidin. In some embodiments, the sterol biosynthesis inhibitor is ipconazole. In some embodiments, the sterol biosynthesis inhibitor is triticonazole. In some embodiments, the sterol biosynthesis inhibitor is spiroxamin. In some embodiments, the sterol biosynthesis inhibitor is fenhexamid. In some embodiments, the sterol biosynthesis inhibitor is fenpyrazamine. In some embodiments, the sterol biosynthesis inhibitor is fenbuconazole.

In some embodiments, the at least one additional fungicide is a succinate dehydrogenase inhibitor.

In some embodiments, the succinate dehydrogenase inhibitor is selected from the group consisting of benzovindiflupyr, penthiopyrad, isopyrazam, fluxapyroxad, boscalid, fluopyram, bixafen, and penflufen.

In some embodiments, the succinate dehydrogenase inhibitor is benzovindiflupyr. In some embodiments, the succinate dehydrogenase inhibitor is penthiopyrad. In some embodiments, the succinate dehydrogenase inhibitor is isopyrazam. In some embodiments, the succinate dehydrogenase inhibitor is fluxapyroxad. In some embodiments, the succinate dehydrogenase inhibitor is boscalid. In some embodiments, the succinate dehydrogenase inhibitor is fluopyram. In some embodiments, the succinate dehydrogenase inhibitor is bixafen. In some embodiments, the succinate dehydrogenase inhibitor is penflufen.

In some embodiments, the at least one additional fungicide is a strobilurin fungicide.

In some embodiments, the strobilurin fungicide is selected from the group consisting of azoxystrobin, pyraclostrobin, picoxystrobin, fluoxastrobin, trifloxystrobin, kresoxim-methyl, dimoxystrobin, and orysastrobin.

In some embodiments, the strobilurin fungicide is selected from the group consisting of azoxystrobin, pyraclostrobin, picoxystrobin, fluoxastrobin, and trifloxystrobin.

In some embodiments, the strobilurin fungicide is azoxystrobin. In some embodiments, the strobilurin fungicide is pyraclostrobin. In some embodiments, the strobilurin fungicide is picoxystrobin. In some embodiments, the strobilurin fungicide is fluoxastrobin. In some embodiments, the strobilurin fungicide is trifloxystrobin. In some embodiments, the strobilurin fungicide is kresoxim-methyl. In some embodiments, the strobilurin fungicide is dimoxystrobin. In some embodiments, the strobilurin fungicide is orysastrobin.

In some embodiments, the at least one additional fungicide is a fungicidal multisite inhibitor.

In some embodiments, the fungicidal multisite inhibitor is selected from a group consisting of mancozeb, chlorothalonil, folpet, captan, metiram, maneb, propineb, copper hydroxide, copper octanoate, copper oxychloride, copper sulfate, copper sulfate (tribasic), mancopper, oxine-copper, copper bis(3-phenlsalicylate), copper zinc chromate, cuprous oxide, cupric hydrazinium sulfate, and cuprobam.

In some embodiments, the fungicidal multisite inhibitor is mancozeb. In some embodiments, the fungicidal multisite inhibitor is chlorothalonil. In some embodiments, the fungicidal multisite inhibitor is folpet. In some embodiments, the fungicidal multisite inhibitor is captan. In some embodiments, the fungicidal multisite inhibitor is metiram. In some embodiments, the fungicidal multisite inhibitor is maneb. In some embodiments, the fungicidal multisite inhibitor is propineb. In some embodiments, the fungicidal multisite inhibitor is copper hydroxide, copper octanoate, copper oxychloride, copper sulfate, copper sulfate (tribasic), mancopper, oxine-copper, copper bis(3-phenlsalicylate), copper zinc chromate, cuprous oxide, cupric hydrazinium sulfate, or cuprobam.

In some embodiments, the additional fungicide is selected from the group consisting of 2-(thiocyanatomethylthio)-benzothiazole, 2-phenylphenol, 8-hydroxyquinoline sulfate, ametoctradin, amisulbrom, antimycin, Ampelomyces quisqualis, azaconazole, azoxystrobin, Bacillus subtilis, Bacillus subtilis strain QST713, benalaxyl, benomyl, benthiavalicarb-isopropyl, benzylaminobenzene-sulfonate (BABS) salt, bicarbonates, biphenyl, bismerthiazol, bitertanol, bixafen, blasticidin-S, borax, Bordeaux mixture, boscalid, bromuconazole, bupirimate, calcium polysulfide, captafol, captan, carbendazim, carboxin, carpropamid, carvone, chlazafenone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, enestrobin, enestroburin, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluoxastrobin, fluquinconazole, flusilazole, flusulfamide, flutianil, flutolanil, flutriafol, fluxapyroxad, folpet, formaldehyde, fosetyl, fosetyl-aluminum, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), iodocarb, ipconazole, ipfenpyrazolone, iprobenfos, iprodione, iprovalicarb, isoprothiolane, isopyrazam, isotianil, kasugamycin, kasugamycin hydrochloride hydrate, kresoxium-methyl, laminarin, mancopper, mancozeb, mandipropamid, maneb, mefenoxam, mepanipyrim, mepronil, meptyl-dinocap, mercuric chloride, mercuric oxide, mercurous chloride, metalaxyl, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrametostrobin, pyraoxystrobin, pyrazophos, pyribencarb, pyributicarb, pyrifenox, pyrimethanil, pyriofenone, pyroquilon, quinoclamine, quinoxyfen, quintozene, Reynoutria sachalinensis extract, sedaxane, silthiofam, simeconazole, sodium 2-phenylphenoxide, sodium bicarbonate, sodium pentachlorophenoxide, spiroxamine, sulfur, SYP-Z048, tar oils, tebuconazole, tebufloquin, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, valifenalate, valiphenal, vinclozolin, zineb, ziram, zoxamide, Candida oleophila, Fusarium oxysporum, Gliocladium spp., Phlebiopsis gigantea, Streptomyces griseoviridis, Trichoderma spp., (RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme, ampropylfos, anilazine, azithiram, barium polysulfide, Bayer 32394, benodanil, benquinox, bentaluron, benzamacril, benzamacril-isobutyl, benzamorf, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, furcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, phenylmercury dimethyldithiocarbamate, phenylmercury nitrate, phosdiphen, prothiocarb, prothiocarb hydrochloride, pyracarbolid, pyridinitril, pyroxychlor, pyroxyfur, quinacetol, quinacetol sulfate, quinazamid, quinconazole, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, urbacid, zarilamid, and any combinations thereof.

In some embodiments, the pesticide is an insecticide. In some embodiments, the pesticide is an acaricides. In some embodiments, the pesticide is a nematicide. In some embodiments, the pesticide is an herbicide.

Examples of insecticides and acaricides may include, but are not limited to, abamectin, pyriproxyfen, acetamiprid, bifenthrin, cyfluthrin, pymetrozine, novaluron, ethiprole, fipronil, and lambda-cyhalothrin.

Examples of nematicide may include, but not limited to fluensulfone.

In some embodiment, compositions according to the invention are selected from emulsifiable concentrates (EC), suspoemulsion concentrates (SE), oil-in-water emulsions (EW), microemulsion (ME).

In some embodiment, compositions according to the invention are emulsifiable concentrates (EC). In one embodiment, compositions according to the invention are oil-in-water emulsions (EW). In one embodiment, compositions according to the invention are microemulsions.

In some embodiment, the compound of formula (I) is completely dissolved in the composition.

In some embodiment, the compound of formula (I) is dissolved is a solvent selected from acetophenone, benzyl acetate, N-butylpyrolidone such as Genegen NBP, N-Formylmorpholine such as ARMID FMPC, cyclohexanone, DMSO and NMP. In some embodiments, the composition comprising the compound of formula (I) and a UV protectant is more efficient for treating a plant or locus against fungal infection than a composition comprising the compound of formula (I) without UV protectant.

In some embodiments, fungicidal efficacy is increased by at least 5%, 10%, 20%, or 30% compared to when the same amount of the compound of formula (I) is applied alone. In some embodiments, fungicidal efficacy is increased by at least 50%, 100%, 200% or 300% compared to when the same amount of the compound of formula (I) is applied alone.

In some embodiments, fungicidal efficacy is measured in a treated area of the plant. In some embodiments, fungicidal efficacy is measured in an untreated area of the plant. In some embodiments, fungicidal efficacy is increased in a treated area of the plant. In some embodiments, fungicidal efficacy is increased in an untreated area of the plant.

In some embodiments, fungicidal efficacy is measure at least 7 days 20 after treatment. In some embodiments, fungicidal efficacy is measure at least 14 days after treatment. In some embodiments, fungicidal efficacy is measure at least 21 days after treatment. In some embodiments, fungicidal efficacy is measure at least 28 days after treatment.

In some embodiments, a substantially similar level of fungicidal efficacy is achieved by using a lesser amount of the compound of Formula (I).

In some embodiments, the compound of Formula I refers to any solid form including but not limited to amorphous, crystalline, solvate or hydrate. Crystalline forms of the compound of Formula I are described in PCT International Application Publication No. WO/2019/038583, published Feb. 28, 2019, and crystalline forms of the compound of Formula III are described in PCT International Application Publication No. WO/2022/234487, published Nov. 10, 2022, the entire content of each is hereby incorporated by reference.

In some embodiment, in the compound of formula (I), R is alkyl; X1, X2, X4 and X5 are each H and X3 is alkyl; Z is fluorine, and/or Y is oxygen.

In some embodiments, in the compound of formula (I), R is methyl, and/or X1, X2, X4 and X5 are each H and X3 is methyl.

In some embodiments, the compound of formula (I) is a compound of formula (I′):

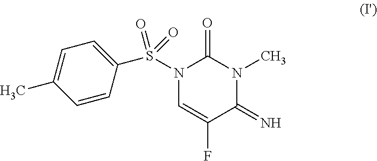

In some embodiment, the applied amount of the compound of Formula I is less than the fungicidally effective amount of the compound of Formula I when the compound of Formula I is applied without a UV absorber.

The present invention further provides a method of controlling the degradation of a compound of formula (I)

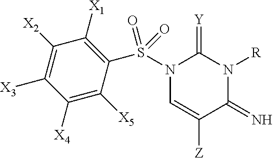

wherein 15
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen;
the method comprising combining at least one UV absorber and the compound of formula (I) in a liquid composition.

In some embodiment, the composition comprises from about 0.1 to 5% by weight, of UV absorber based on the total wight of the composition. In one embodiment, the compositions comprise from about 0.5 to 3% by weight, of UV absorber based on the total wight of the composition. In one embodiment, the compositions comprise from about 1% to 2% by weight, of UV absorber based on the total weight of the composition. In one embodiment, the compositions comprise about 1% by weight, of UV absorber based on the total weight of the composition. In one embodiment, the compositions comprise about 1.5% by weight, of UV absorber based on the total weight of the composition. In one embodiment, the compositions comprise about 2% by weight, of UV absorber based on the total weight of the composition.

The concentration of the UV absorber is about 1 to 50 g/L, based on the total wight of the composition. In some embodiments, the concentration of the UV absorber is about 10 to 21 g/L, based on the total weight of the composition, including each value within the specified range. Each possibility represents a separate embodiment of the invention.

The concentration of the compound of Formula (I) is from about 1 to 20% by weight, based on the total wight of the composition. In some embodiments, the concentration of the compound of Formula (I) is from about 1% to 10% by weight, based on the total wight of the composition. In some embodiments, the concentration of the compound of Formula (I) is from about 4% to 7% by weight, based on the total wight of the composition. In some embodiments, the concentration of the compound of Formula (I) is about 5% by weight, based on the total wight of the composition.

The concentration of the compound of Formula (I) is about 1 to 200 g/L, based on the total wight of the composition. In some embodiments, the concentration of the compound of Formula (I) is from about 10 g/L to 100 g/L, based on the total wight of the composition. In some embodiments, the concentration of the compound of Formula (I) is from about 40 g/L to 70 g/L, based on the total wight of the composition. In some embodiments, the concentration of the compound of Formula (I) is about 50 g/L, based on the total wight of the composition. The weight ratio between the compound of Formula (I) and the UV absorber is between 200:1 to 1:50. In some embodiments, the weight ratio between the compound of Formula (I) and the UV absorber is between 10:1 to 1:1. In some embodiments, the weight ratio between the compound of Formula (I) and the UV absorber is between 5:1 to 1:1. the weight ratio between the compound of Formula (I) and the UV absorber is between 10:1 to 2:1. In some embodiments, the weight ratio between the compound of Formula (I) and the UV absorber is between 5:1 to 2:1.

In some embodiments, the UV absorber is selected from benzotriazoles.

Suitable benzotriazoles are the compound 2-(2H-benzotriazol-2-yl)-4, 6-ditertpentylphenol (Tinuvin 328), 2-(5-chloro-2H-benzotriazol-2-yl)-6-(1,1-dimethylethyl)-4-methyl phenol (Tinuvin 326), 2-(2H-Benzotriazol-2-yl)-4,6-bis(1-methyl-1-phenylethyl)phenol (Tinuvin 234), and 2-(2′-Hydroxy-3′,5′-di-tert-butylphenyl)-5-chlorobenzotriazole (Tinuvin 327).

In some embodiments, the composition comprises a photoinitiator.

In some embodiments, the photoinitiator is the solvent.

In some embodiments, the solvent is selected from acetophenone, benzyl acetate, N-butylpyrolidone such as Genegen NBP, N-Formylmorpholine such as ARMID FMPC, cyclohexanone, DMSO and NMP.

In some embodiments, acetophenone acts as the photoinitiator.

In some embodiments, the composition further comprises at least one additive such as an antifreeze, a stabilizer, a tackifier, a preservative, a surfactant, and a combination thereof.

The present invention further provides use of at least one UV absorber for controlling the degradation of a compound of formula (I)

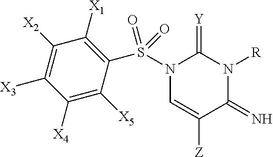

wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen;
in the liquid composition as described herein.

The present invention further provides a method of controlling a plant disease, the method comprising applying a composition comprising a compound of formula (I) and a UV absorber to the plant.

The present invention further provides a method of controlling a plant disease, the method comprising applying to the plant or a locus of the plant the compound of formula (I) in a low-UV light environment.

In some embodiments, the compound of formula (I) is formulated in a liquid composition.

Suitable liquid composition according to the present invention are selected from emulsion concentrate (EC), suspoemulsion concentrates (SE), oil-in-water (EW) and microemulsion (ME).

In some embodiments, the compound of formula (I) is dissolved in the formulation.

In some embodiments, the method is effective for treating the plant or locus against fungal infection.

In some embodiments, controlling fungal infection comprises treating fungal disease infecting the plant or locus. In some embodiments, controlling fungal infection comprises treating a plant or soil disease caused by phytopathologic fungi. In some embodiments, controlling fungal infection comprises treating fungal attack on the plant or locus. In some embodiments, controlling fungal infection comprises reducing fungal infection of the plant or locus. In some embodiments, controlling fungal infection comprises curing a plant or soil disease caused by phytopathologic fungi.

In some embodiments, the method is effective for protecting the plant or locus against fungal infection.

In some embodiments, controlling the plant or locus against fungal infection comprises protecting the plant or locus against fungal attack. In some embodiments, controlling the plant or locus against fungal infection comprises protecting the plant or locus from fungal disease. In some embodiments, controlling the plant or locus against fungal infection comprises preventing fungal infection of the plant or locus.

In some embodiments, the composition is applied in an amount from 1 g/ha to 500 g/ha, based on the total amount of active ingredients. In some embodiments, the composition is applied in an amount from 1 g/ha to 400 g/ha, based on the total amount of active ingredients. In some embodiments, the composition is applied in an amount from 1 g/ha to 300 g/ha, based on the total amount of active ingredients. In some embodiments, the composition is applied in an amount from 1 g/ha to 200 g/ha, based on the total amount of active ingredients. In some embodiments, the composition is applied in an amount from 1 g/ha to 100 g/ha, based on the total amount of active ingredients. In some embodiments, the composition is applied in an amount from 25 g/ha to 175 g/ha, based on the total amount of active ingredients. In some embodiments, the composition is applied in an amount from 50 g/ha to 150 g/ha, based on the total amount of active ingredients. In some embodiments, the composition is applied in an amount from 75 g/ha to 125 g/ha, based on the total amount of active ingredients. In some embodiments, the composition is applied in an amount of 100 g/ha, based on the total amount of active ingredients.

The compositions disclosed herein may be applied to control a variety of fungal pathogens and diseases associated therewith. In some embodiments, the fungal pathogen is one of Mycosphaerella graminicola, Septoria tritici, Puccinia triticina, Puccinia striiformis f. sp. tritici, Venturia inaequalis, Ustilago maydis, Uncinula necator, Rhynchosporium secalis, Magnaporthe grisea, Phakopsora pachyrhizi, Leptosphaeria nodorum, Blumeria graminis f. sp. tritici, Blumeria graminis f. sp. hordei, Erysiphe cichoracearum, Glomerella lagenarium, Cercospora beticola, Alternaria solani, Pyrenophora teres, Ramularia, Peronospora spp., Botrytis cinereal, and Mycosphaerella fijiensis.

In some embodiments, the fungal pathogen is Septoria. In some embodiments, the fungal pathogen is Zymoseptoria tritici (SEPTTR). In some embodiments, the fungal pathogen is Rhyncosporium. In some embodiments, the fungal pathogen is Pyrenophora. In some embodiments, the fungal pathogen is Microduchium majus. In some embodiments, the fungal pathogen is Sclerotinia. In some embodiments, the fungal pathogen is Cercosporea beticola.

In some embodiments, the fungal disease is one of Leaf Blotch of Wheat (Mycosphaerella graminicola; anamorph: Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), Net Blotch of Barley (Pyrenophora teres), Downy Mildew of vegetables (Peronospora spp.), Downy Mildew of Brassicas (Peronospora spp.), Downy Mildew of Cucurbits (Peronospora spp.), Gray Mold of Grape (Botrytis cinereal), Gray Mold of Vegetables (Botrytis cinereal), and Banana Black sigatoka (Mycosphaerella fijiensis).

In some embodiments, the plant or soil disease is one of leaf spot, brown rust, yellow rust, powdery mildew, downy mildew, gray mold, Asian soybean rust, and black sigatoka.

In some embodiments, the plant is a crop plant. The methods of the present invention may be used on any crop plants, including but not limited to monocotyledons such as sugar cane cereals, rice, maize (corn), and/or; or dicotyledon crop such as beets (such as sugar beet or fodder beet); fruits (such as pomes, stone fruits, or soft fruits, for example apples, pears, plums, peaches, almonds, cherries, strawberries, raspberries, or blackberries); leguminous plants (such as beans, lentils, peas, or soybeans); oil plants (such as rape, mustard, poppy, olives, sunflowers, coconut, castor oil plants, cocoa beans, or groundnuts); cucumber plants (such as marrows, cucumbers or melons); fiber plants (such as cotton, flax, hemp, or jute); citrus fruits (such as oranges, lemons, grapefruit, or mandarins); vegetables (such as spinach, lettuce, cabbages, carrots, tomatoes, potatoes, cucurbits, or paprika); lauraceae (such as avocados, cinnamon, or camphor); tobacco; nuts; coffee; tea; vines; hops; durian; bananas; natural rubber plants; and ornamentals (such as flowers, shrubs, broad-leaved trees, or evergreens, for example conifers).

In some embodiments, the plants are monocotyledonous plants, more preferably, cereals. In a specific embodiment, the cereal crop is wheat. In another specific embodiment, the cereal crop is triticale. In another specific embodiment, the cereal crop is rye. In another specific embodiment, the cereal crop is oat. In a further embodiment, the cereal crop is barley. In another embodiment, the crop plants are rice plants. In still another embodiment, the crop plants are sugar cane plants. In yet another embodiment, the crop plants are corn plants.

In another embodiment, the crop plants are dicotyledonous plants.

In one embodiment, the crop plants are oil seed rape plants.

The present composition can be applied to fungi or their locus. Application may be made by the use of conventional ground sprayers, and by other conventional means known to those skilled in the art.

### EXPERIMENTAL SECTION

### Example 1

the photostability of a 50 g/L of compound (I′) EC composition was analyzed.

The EC composition containing 50 g/L of the compound of Formula (I′) is summarized in the following table:

| | for 1 L (gr) | % |
|---|---|---|
| Compound (I′) | 52.08 | 5.01 |
| Soprophor ® TS/16 | 239 | 22.98 |
| Synergen SOC | 57 | 5.48 |
| Agnique 420 | 57 | 5.48 |
| gap for UV protector | Between 10.14-20.8 | Between 1-2% |
| Acetophenone | Complete to volume | Complete to 100% |
| Total | 1040 | 100 |

The following were added to the composition:

| | | |
|---|---|---|
| UV absorber: | 2-(2H-benzotriazol-2-yl)-4,6- | (Tinuvin 328) |
| | ditertpentylphenol | |
| Antioxidant: | Ethylene bis(oxyethylene) bis-(3-(5-tert- | (Irganox 245) |
| | butyl-4-hydroxy-m-tolyl)propionate) | |
| Antioxidant: | Butylated Hydroxytoluene | (BHT) |

The degradation of compound (I′) was checked after being exposed to UV (sunlight simulation lamp) for up to 8 hrs.

### Results

| | | 2 | | 4 | 5 |
|---|---|---|---|---|---|
| | 1 | Compound | 3 | Compound | Compound |
| | Compound | (I′) conc | Compound | (I′) conc | (I′) conc |
| | (I′) (%) - | (%) with 1% | (I′) conc | (%) with 1% | (%) with 1% |
| Time | No UV | Tinuvin | (%) with 1% | Tinuvin 328 + | Irganox |
| (hr) | protector | 328 | BHT | 1% BHT | 245 |
| 0 | 4.69 | 4.68 | 4.66 | 4.69 | 4.72 |
| 1 | 4.21 | 4.68 | 4.27 | 4.62 | 4.15 |
| 4 | 2.9 | 4.51 | 3.11 | 4.54 | 2.82 |
| 8 | 1.81 (38%) | 4.19 (90%) | 1.74 (37%) | 4.36 (93%) | 1.74 (37%) |

Compound (I′) (%) means the concentration of the compound (I′) in the composition.
(XX %) after 8 hr means the concentration of the compound (I′) relative to the starting concentration.

### DISCUSSION

The results demonstrate that the addition of a UV absorber to the composition provided a significant decrease in the degradation of the compound (I′) (composition 2). The concentration of the compound (I′) relative to the starting concentration was in the range of 90-95% after 8 hr. The addition of another antioxidant to the composition comprising a UV absorber did not provide any added value (composition 4). In contrast, without any UV protection (composition 1), or the addition of antioxidants (compositions 3 and 5) did not provide any significant protection to the compound (I′) from degradation.

1. A method of controlling UV degradation of a compound of formula (I), 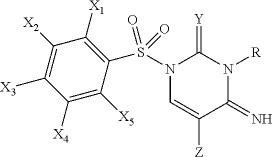
wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen,
comprising protecting the compound of formula (I) from UV light.

2. The method of claim 1, wherein:
(a) the compound of formula (I) is placed in a container with UV protection,
(b) the compound of formula (I) is combined with a UV absorber, and/or
(c) the compound of formula (I) is placed in low UV light environment.

3. The method of claim 2, wherein the UV absorber is a benzotriazole.

4. The method of claim 3, wherein the benzotriazole is selected from:
2-(2H-benzotriazol-2-yl)-4, 6-ditertpentylphenol,
2-(2H-Benzotriazol-2-yl)-4,6-bis(1-methyl-1-phenylethyl)phenol,
2-(5-chloro-2H-benzotriazol-2-yl)-6-(1,1-dimethylethyl)-4-methyl phenol, and
2-(2′-Hydroxy-3′,5′-di-tert-butylphenyl)-5-chlorobenzotriazole.

5. The method of any one of claims 1-4, wherein the compound of formula (I) is formulated in a liquid composition.

6. The method of claim 5, wherein the liquid composition is selected from emulsion concentrate (EC), suspoemulsion concentrates (SE), oil-in-water (EW) and microemulsion (ME).

7. A combination of a compound of formula (I) 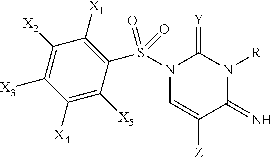
wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen,
and a UV protectant.

8. The combination of claim 7, wherein the UV protectant is (a) a container with UV protection, or (b) a UV absorber.

9. The combination of claim 8, wherein the UV absorber is a benzotriazole.

10. The combination of claim 9, wherein the benzotriazole is selected from:
2-(2H-benzotriazol-2-yl)-4, 6-ditertpentylphenol,
2-(2H-Benzotriazol-2-yl)-4,6-bis(1-methyl-1-phenylethyl)phenol,
2-(5-chloro-2H-benzotriazol-2-yl)-6-(1,1-dimethylethyl)-4-methyl phenol, and
2-(2′-Hydroxy-3′,5′-di-tert-butylphenyl)-5-chlorobenzotriazole.

11. The combination of any one of claims 7-10, wherein the compound of formula (I) is formulated in a liquid composition.

12. The method of claim 11, wherein the liquid composition is selected from emulsion concentrate (EC), suspoemulsion concentrates (SE), oil-in-water (EW) and microemulsion (ME).

13. A liquid composition comprising a compound of formula (I) 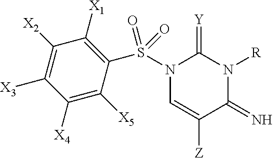
wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen; and
at least one UV absorber.

14. The liquid composition of claim 13, wherein the concentration by weight of the UV absorber is from about 0.1% to about 5%, based on the total wight of the composition.

15. The liquid composition of claim 13 or 14, wherein the concentration of the UV absorber is 0.1 g/L to about 25 g/L, based on the total wight of the composition.

16. The liquid composition of any one of claims 13-15, wherein the concentration by weight of the compound of Formula (I) is from about 0.1% to about 20%, based on the total wight of the composition.

17. The liquid composition of any one of claims 13-16, wherein the concentration of the compound of Formula (I) is 1 g/L to about 200 g/L, based on the total wight of the composition.

18. The liquid composition of any one of claims 13-17, wherein the weight ratio between the compound of Formula (I) and the UV absorber is between 200:1 to 1:50.

19. The liquid composition of any one of claims 13-18, wherein the composition is an emulsion concentrate (EC).

20. The liquid composition of any one of claims 13-19, wherein the composition is an oil-in-water emulsion (EW).

21. The liquid composition of any one of claims 13-18, wherein the compound of formula (I) is dissolved in the composition.

22. The liquid composition of any one of claims 13-21, wherein the composition comprises a photoinitiator.

23. The liquid composition of claim 22, wherein the photoinitiator is the solvent.

24. The liquid composition of claim 23, wherein the solvent is acetophenone, benzyl acetate, N-butylpyrolidone such as Genegen NBP, N-Formylmorpholine such as ARMID FMPC, cyclohexanone, DMSO and NMP.

25. The liquid composition of any one of claims 13-24, wherein the UV absorber is a benzotriazole.

26. The liquid composition of claim 25, wherein the benzotriazole is selected from:
2-(2H-benzotriazol-2-yl)-4, 6-ditertpentylphenol,
2-(2H-Benzotriazol-2-yl)-4,6-bis(1-methyl-1-phenylethyl)phenol,
2-(5-chloro-2H-benzotriazol-2-yl)-6-(1,1-dimethylethyl)-4-methyl phenol, and
2-(2′-Hydroxy-3′,5′-di-tert-butylphenyl)-5-chlorobenzotriazole.

27. The liquid composition of claim 26, wherein the UV absorber is the compound 2-(2H-benzotriazol-2-yl)-4, 6-ditertpentylphenol.

28. A liquid composition comprising a compound of formula (I) 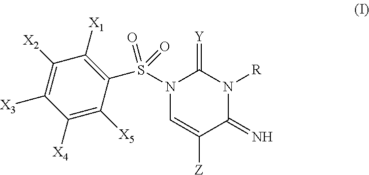
wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen;
acetophenone; and
the compound 2-(2H-benzotriazol-2-yl)-4, 6-ditertpentylphenol.

29. The liquid composition of any one of claims 13-28, further comprising at least one additional agrochemical.

30. The liquid composition of claim 29, wherein the additional agrochemical is a fungicide.

31. Use of at least one UV protectant for controlling the degradation of a compound of formula (I) 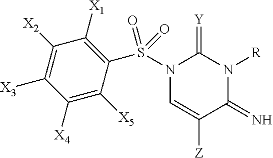
wherein
R is alkyl or alkylaryl;
each of X₁, X₂, X₃, X₄ and X₅ is, independently, H, alkyl, alkenyl, alkynyl, alkoxy, haloalkyl, haloalkoxy, alkylthio, haloalkylthio, amino, alkylamino, dialkylamino, alkoxycarbonyl, alkyl carbonyl, hydroxyalkyl, ester, acid halogen, —SH, —OH, —NH₂, —NO₂, —CN or CF₃;
Y is O or S;
and Z is a halogen.

32. The use of claim 31, wherein the UV protectant is (a) a container with UV protection, or (b) a UV absorber.

33. The use of claim 31 or 32, wherein the compound of formula (I) is formulated in the liquid composition of any one of claims 13-30.

34. A method of controlling a plant disease, the method comprising applying the composition of any one if claims 13-30 to the plant.

35. The method, liquid composition, or use of any one of claims 1-34, wherein in the compound of formula (I):
R is alkyl;
X₁, X₂, X₄ and X₅ are each H and X₃ is alkyl;
Z is fluorine, and/or
Y is oxygen.

36. The method, liquid composition, or use of claim 35, wherein the compound of formula (I) is a compound of formula (I′): 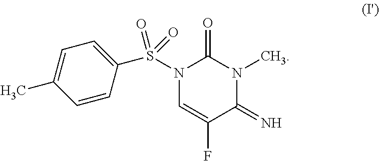 [SMILES: Cc1ccc(S(=O)(=O)n2cc(F)c(=N)n(C)c2=O)cc1]
